(19) United States
(12) Patent Application Publication
(10) Pub. No.: US 2008/0302192 A1
(43) Pub. Date: Dec. 11, 2008

(54) Apparatus and Method For Detecting an Analyte

(76) Inventor: Bernard A. Gonzalez, St. Paul, MN (US)

Correspondence Address: 3M INNOVATIVE PROPERTIES COMPANY, PO BOX 33427, ST. PAUL, MN, 55133-3427, US

(21) Appl. No.: 11/997,578

(22) PCT Filed: Aug. 2, 2006
(86) PCT No.: PCT/US2006/030340

§ 371 Date: Jul. 21, 2008

Related U.S. Application Data
(60) Provisional application No. 60/705,090, filed on Aug. 2, 2005.

(51) Int. Cl. B01L 3/00

(52) U.S. Cl. 73/864.51

(57) ABSTRACT

An apparatus for detecting an analyte in a sample of material is disclosed. The apparatus includes a frame and a plurality of chambers. The frame may be manipulated to form at least a first flow path and a second flow path through the chambers.

### CROSS REFERENCE TO RELATED APPLICATIONS

This application claims the benefit of U.S. Provisional Patent Application No. 60/705,090, filed Aug. 2, 2005, which is incorporated by reference herein.

### BACKGROUND

Many industries, such as the medical and food service industries, often require the testing of a sample of material in order to determine whether a certain biological bacterium or other organism is present. The presence of such an organism may be indicative of a problem. For example, the presence of the organism may indicate the presence of infection in a person or the presence of a contaminant in food or on a food preparation surface.

In existing methods of testing the sample of material, a sample collection device, such as a swab, which includes a porous medium on the end of a shaft, may be used to gather the sample of material. Specifically, the porous medium of the swab may be placed in contact with a sample source, such as a nose, ear, throat or wound of a person, or a food preparation surface, and a sample may then adhere to the porous medium. Thereafter, the sample collection device may be transferred to a different location, such as a laboratory, where the collected sample is transferred from the sample collection device to a slide or other external laboratory apparatus in order to run an assay to analyze whether the particular organism of interest is present. The particular organism of interest may be referred to as an “analyte”.

In addition to a delay in time, the transfer of the sample collection device from the sample source to the off-site location may cause the collected sample to become contaminated or dry out, which may decrease the reliability of the analyte detection. Furthermore, a non-self contained testing device or method may be problematic because the lab technician may be exposed to the analyte during the testing process. The present invention addresses these and/or other problems and provide advantages over prior methods or devices.

### BRIEF SUMMARY

In one aspect, an apparatus is disclosed for processing a biological sample. In embodiments described, the apparatus includes a plurality of chambers. Chambers are formed by a housing material, which is attached to a frame. In the illustrated embodiments, the plurality of chambers include a sample introduction chamber, a waste chamber, a fluid chamber and a testing chamber. As disclosed a capture medium is interposed in a flow path between the sample introduction chamber and the waste chamber and a flow path between the fluid chamber and the testing chamber. The frame is bendable to restrict flow along at least one of the flow paths for processing the biological sample.

In another aspect, a method is disclosed for detecting an analyte in a sample of material. The method comprises introducing the sample of material into a sample introduction chamber of an apparatus and eluting the sample of material, capturing the eluted sample of material using a capture medium, folding a frame of the apparatus along an axis, and releasing a fluid from a fluid reservoir and directing the fluid along a flow path through the capture medium to a testing chamber.

In another aspect, a method is disclosed of detecting an analyte in a sample of materiel. The method comprises introducing a sample of material into a sample introduction chamber of an apparatus and eluting the sample of material, capturing the eluted sample of material using a capture medium, rotating the apparatus about ninety degrees, and releasing a fluid disposed in a fluid reservoir and directing the fluid along a flow path through the capture medium to a testing chamber.

The above summary is not intended to describe each disclosed embodiment or every implementation of the present invention. The figures and the detailed description which follow more particularly exemplify illustrative embodiments.

### BRIEF DESCRIPTION OF THE DRAWINGS

The present invention will be further explained with reference to the drawing figures listed below, where like structure is referenced by like numerals throughout the several views.

FIG. 1A is a perspective view of an exemplary embodiment of an apparatus of the present invention, which includes a base supporting a frame, where the apparatus includes a plurality of chambers 16, 18, 20, 22, and 24.

FIG. 1B is a schematic illustration to illustrate operation of the apparatus of FIG. 1.

FIG. 2 is a perspective view of the apparatus of FIG. 1, where the frame has been folded along axis A (shown in FIG. 1A)

FIG. 3 is a perspective view of the apparatus of FIG. 1, where the frame has been folded along axis B (shown in FIG. 1A).

FIG. 4 is a perspective view of the apparatus of FIG. 3, where the apparatus has been rotated about 90 degrees.

While the above-identified figures set forth an exemplary embodiment of the present invention, other embodiments are also within the invention. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION

The present invention is a substantially self-contained apparatus for running an assay to detect an analyte, such as staphylococcus aureus, in a sample of material, where the apparatus includes a frame and a housing material, where the housing material forms a plurality of chambers. The frame may be manipulated to form at least, a first flow path through one or more chambers and a second flow path through at least one or more chambers. At least one chamber of the apparatus is configured to receive a sample of material. In the exemplary embodiment, a chamber is configured to receive a sample acquisition device that contains a sample of material. Disposed within the chambers are the necessary buffer solutions, a testing device, and other components that are necessary for running the assay. This will be described in further detail below.

In the exemplary embodiment, the apparatus includes five chambers. The frame is manipulated by both folding the frame and rotating the frame about 90 degrees (°). By folding the frame, a flow path through the chambers is modified, and as a result, different chambers are fluidically connected with one another. Prior to rotating the frame about 90°, fluid is encouraged by gravity to flow along a first flow path through the central chamber; rotating the frame about 90° encourages fluid to flow along a second flow path through the central chamber. An apparatus operator may control the timing of an assay because the operator may change the various flow paths through the apparatus by manipulating the frame.

The apparatus is substantially self-contained because generally all the chemistry for detecting the analyte is generally contained in the chambers. This decreases the chance that an apparatus operator will be exposed to the analyte and/or fluids that are used in the testing process, such as by an accidental spill or otherwise. The inventive apparatus assembly is a relatively simple device that allows a sample of material to be tested for an analyte at or near the sample source. Rather than transferring the sample of material to an off-site laboratory, the present invention allows an operator to obtain a sample of material from a sample source and then test the sample for the presence of an analyte at or near the sample source. This helps to decrease the waiting time for a test result as well as helps to decrease the chances that the sample of material will become contaminated or dried out prior to testing. Further, a sample acquisition device containing the sample of material may be directly introduced into an apparatus of the present invention. This may decrease operator exposure to the sample of material, which may contain a hazardous analyte. Furthermore, the apparatus assembly may be disposable, which helps to provide a clean, if not sterile, apparatus assembly for each use.

The inventive apparatus may also be used in a laboratory or other off-site setting. Rather than an operator manually manipulating the frame in order to adjust the flow path through the chambers, a machine may mechanically manipulate the frame after a preset amount of time.

The present invention is described in reference to an exemplary embodiment, which uses an indirect assay to detect an analyte in a sample of material. A general understanding of the assay process that is used with the exemplary embodiment will help aid in the description of the inventive apparatus. However, the following description of the assay process is not intended to limit the present invention in any way. Rather, the inventive apparatus and method of detecting an analyte in a sample of material may be applied to many different types of assays, direct or indirect.

In accordance with the exemplary embodiment, a sample of material is collected with a sample collection device. For example, the sample may be collected on a porous medium (e.g., a fibrous bud or bristles) that is attached to an end of a hollow shaft. Examples of suitable sample acquisition devices are described in U.S. Pat. No. 5,266,266, entitled, “SPECIMEN TEST UNIT”, and U.S. Patent Application Ser. No. 60/705,140, entitled, “APPARATUS AND METHOD FOR COLLECTING A SAMPLE OF MATERIAL,” (Attorney Docket No. 61097US002) which was filed on Aug. 2, 2005.

Prior to running the assay, the sample of material is prepared. In the sample preparation stage, the sample of material is eluted (or “released”) from the sample collection device with a first buffer solution, rendering an eluted sample. Hereinafter, “eluted sample” refers to a combination of the sample that is removed from the sample acquisition device and the first buffer solution. Examples of suitable buffer solutions include, but are not limited to, water, physiological saline, pH buffered solutions, or any other solutions or combinations of solutions that elute an analyte from the sample acquisition device. The buffer solution preferably does not interfere with the assay. At least some of the analyte is then isolated from the eluted sample. This is done with a capture medium. Examples of suitable capture media include, but are not limited to, beads, a porous membrane, a foam, a frit, a screen, or combinations thereof. In some embodiments, the capture media may be coated with a ligand specific to the analyte, e.g. an antibody. In other embodiments, other means for isolating the analyte may be used.

The sample of material is typically a heterogeneous mixture of material. It may be necessary to isolate and, in some sense, concentrate the analyte because some analytes are only detected in large quantities. The isolation/concentration may increase the chance of an accurate detection. In the present invention, the analyte is isolated from the remaining debris in the sample of material order to help increase the possibility that a testing device will detect the analyte. The testing device may be any suitable device, such as a colorimetric sensor.

An exemplary analyte of interest to detect is Staphylococcus aureus (“S. aureus”. This is a pathogen causing a wide spectrum of infections including: superficial lesions such as small skin abscesses and wound infections; systemic and life threatening conditions such as endocarditis, pneumonia and septicemia; as well as toxinoses such as food poisoning and toxic shock syndrome. Some strains (e.g., Methicillin-Resistant S. aureus or MRSA) are resistant to all but a few select antibiotics.

At least some of the analyte captured by the capture medium is then released (or lysed) therefrom with a second buffer solution. The second buffer solution may contain a lysing agent, such as those described in U.S. Patent Application Publication No. 2005/0153370 A1, entitled “Method of Enhancing Signal Detection of Cell-Wall Components of Cells.”

The released analyte and second buffer solution is then put in contact with a reagent that is adapted to react with the released analyte. If a direct assay is used, a reagent may not be necessary. After the analyte and reagent react, and after a sufficient “reaction time”, the analyte and reagent, along with the second buffer solution, contact the testing device. In an indirect assay, a testing device detects the presence of a reagent adapted to react with the analyte rather than the analyte itself. Specifically, the reagent and analyte react, and then any remaining reagent (i.e., the reagent that has not reacted with the analyte to form a separate product) reacts with the testing device. Thereafter, the testing device provides a visual indicium of the presence and/or quantity of reagent. It is preferred that the analyte and reagent are given sufficient time to react prior to contacting the testing device.

In one embodiment, the reagent reacts with a surface of the testing device (e.g., a blue color), and the testing device changes color as the reagent reacts with the testing device. If a large quantity of reagent reacts with the testing device, the testing device may change color, for example, from blue to red. If a small quantity of reagent reacts with the testing device, the testing device may not change color and remain blue. The testing device may also be configured to provide an indicium of the quantity of reagent present (which typically represents the quantity of analyte present in the sample of material). For example, the testing device may change color, where the intensity or hue of the color changes depending upon the amount of reagent present. In alternate embodiments, the testing device measures the amount of reagent in another suitable way.

The quantity of reagent present indicates the quantity of analyte present because typically, a large quantity of reagent present after the reaction with the analyte indicates that there was not a large quantity of analyte present in the sample of material. Similarly, a small quantity of reagent present after the reaction with the analyte indicates that there was a large quantity of analyte present in the sample of material.

For clarity of description, the five chambers of the present invention are referred to by a functional name. However, the names are not intended to limit the present invention in any way. An apparatus in accordance with the present invention may include any suitable number of chambers. The number of chambers may depend on, for example, the type of assay chemistry used. Those skilled in the art may modify the exemplary embodiment in order to adapt the present invention to a different type of assay.

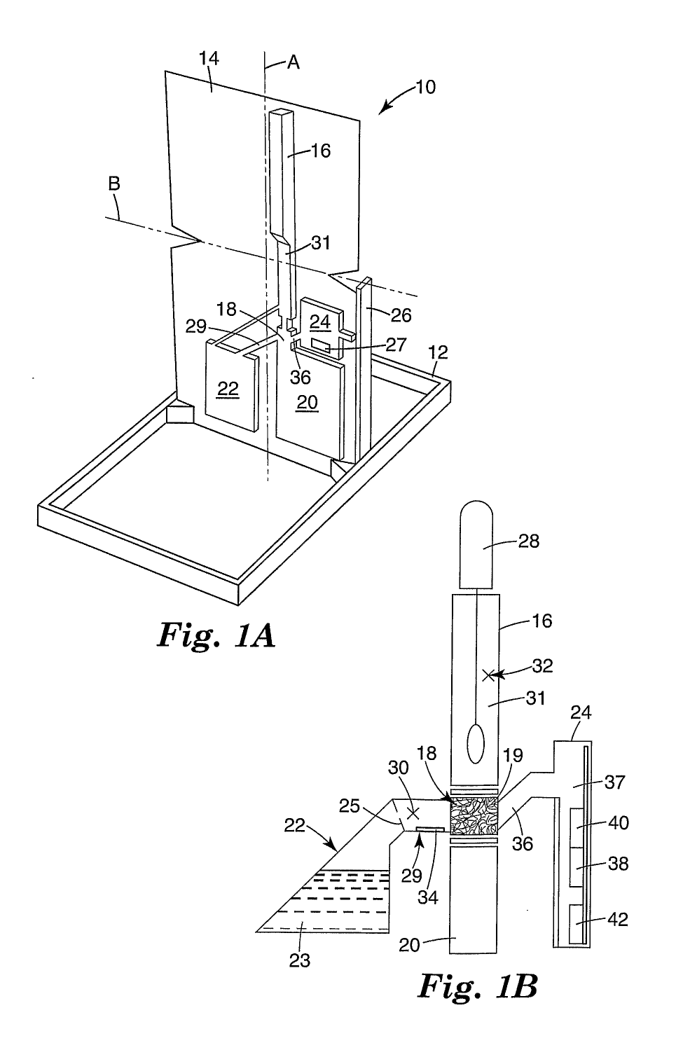

FIG. 1A is a perspective view of an exemplary embodiment of apparatus 10 of the present invention. Apparatus 10 includes base 12, frame 14, sample introduction chamber 16, capture chamber 18, waste chamber 20, fluid reservoir or chamber 22, and testing chamber 24. Base 12 is configured to support frame 14 in a generally upright orientation relative to a horizontal surface on which base 12 is placed. Base 12 includes stand 26, which is also configured to support frame 14 in a generally upright orientation (see e.g., FIG. 4).

Frame 14 is a semi-rigid material, such as cardboard, plastic, metal foil, or a combination of the same. In some embodiments, frame 14 may include a protective coating in order to help frame 14 resist fluids and to help protect frame 14 from damage due to exposure to fluids (e.g., water damage). In the exemplary embodiment, chambers 16, 18, 20, 22, and 24 are formed of a single piece of a flexible film, such as a plastic film, that is attached to one side of frame 14 using any suitable method, such as a pressure sensitive adhesive. As a result of this construction, apparatus 10 has a relatively low profile (e.g., less than 2.5 centimeters thick). Preferably, the film and frame 14 are attached so as to form a leak proof assembly. Chambers 16, 18, 20, 22, and 24 may be formed by any suitable method, including vacuum forming a sheet of flexible film to form a plurality of blister-like chambers or by attaching the flexible film to frame 14 and injection blow molding each chamber.

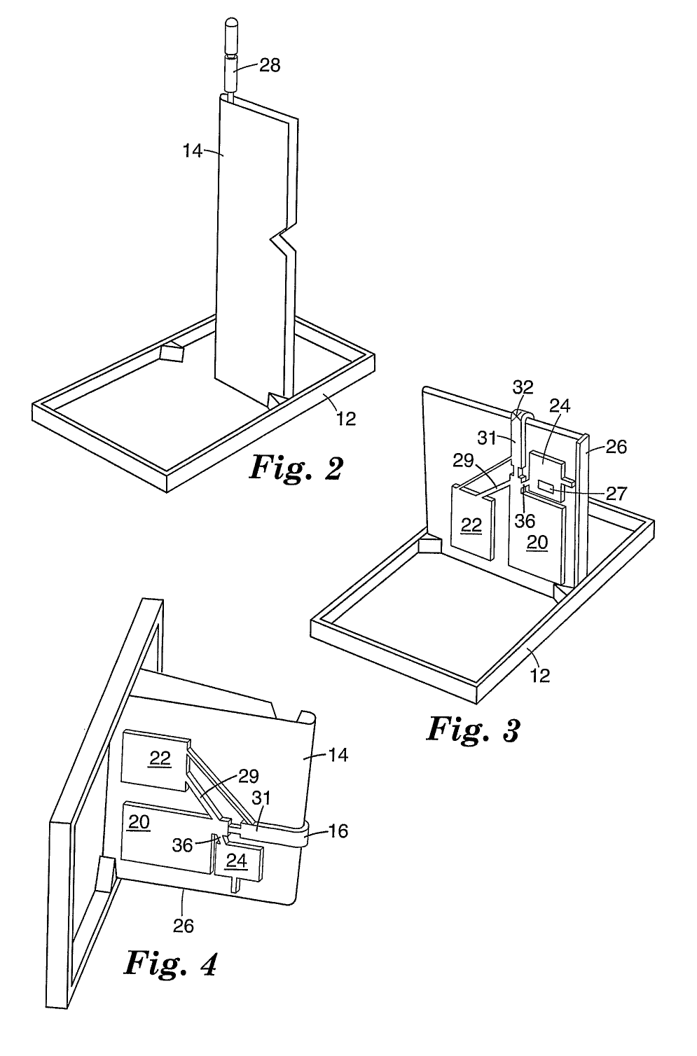

Sample introduction chamber 16 is configured to receive a sample acquisition assembly (e.g., sample acquisition assembly 28 shown in FIGS. 1B and 2), which includes a sample acquisition device and a first fluid, such as a buffer solution, for eluting a sample from the sample acquisition device. The first fluid may be retained in a fluid reservoir until an operator wishes to elute the sample from the sample acquisition device. After a sample is collected with the sample acquisition device, the device is introduced into sample introduction chamber 16.

Disposed in capture chamber 18 is capture medium 19 (shown in FIG. 1B) adapted to capture an analyte from the sample of material, where the capture chamber is in fluidic communication with the sample introduction chamber 16. Waste chamber 20 is in fluidic communication with capture chamber 18. Fluid reservoir 22 is configured to retain second fluid 23 (shown in FIG. 1B). Fluid reservoir 22 is also in selective fluidic communication with capture chamber 18. A frangible seal 25 (shown in FIG. 1B) is disposed between fluid reservoir 22 and capture chamber 18 in order to help fluid reservoir or chamber 22 retain the second fluid until an operator purposefully releases the second fluid.

Testing chamber 24 is configured to be in fluidic communication with capture chamber 18. Pathway 36 fluidically connects capture chamber 18 with testing chamber 24. Testing chamber 24 includes testing device 38 (shown in FIG. 1B) capable of detecting the analyte. In the exemplary embodiment, testing device 38 provides a visual indicium of whether the analyte is present in the sample of material collected with the sample acquisition device, and in some embodiments, the test result indicates the quantity of analyte. In the exemplary embodiment, testing device is a calorimetric sensor, which may include, for example, a polydiacetylene material, as described in U.S. Patent Application Publication No. 2004/0132217 A1, and U.S. Patent Application Ser. No. 60/636,993, filed on Dec. 17, 2004, both entitled, “COLORIMETRIC SENSORS CONSTRUCTED OF DIACETYLENE MATERIALS”.

In the exemplary embodiment, a color of testing device 38 after the assay is run corresponds to a color-coding scheme. Testing device 38 may or may not provide a color change, depending upon whether the analyte is present in the sample of material. A user may view this color change through window 27. The color change may also be graded in order to indicate the quantity of analyte present. The quantity of analyte may, for example, be indicated a color gradient which corresponds to “low level”, “medium level”, or “high level” indications. In some embodiments, apparatus 10 includes a label that illustrates the color-coding scheme, and an operator may compare the resulting color in window 27 (shown in FIG. 1A) with the label. In other embodiments, the color change cannot be detected with a human eye, and a machine or electronic reader, such as a spectrometer, is used to detect the color change. In alternate embodiments, other testing devices may be used. For example, apparatus 10 may incorporate a testing device whose indicium of a test result is characterized by a pH change, or some other change in the characteristic of the medium being analyzed.

FIG. 1B is a schematic of apparatus 10 of FIG. 1A, where frame 14 is eliminated from the schematic. Sample acquisition assembly 28 has been introduced into sample introduction chamber 16. Sample acquisition assembly 28 is a general depiction of a suitable sample acquisition device, and is not intended to limit the present invention in any way. Similarly, capture medium 19 in capture chamber 18 is a general depiction of a capture medium and is not intended to limit the present invention in any way. Fluid reservoir 22 includes fluid 23. Pathway 29 fluidically connects fluid reservoir 22 and capture chamber 18. Disposed within pathway 29 is the frangible seal 25 and frangible pouch 34, which contains a dehydrated reagent.

FIG. 2 shows a configuration of frame 14 during a sample introduction stage. Frame 14 is folded along a first axis A, which is shown in FIG. 1A. Sample acquisition assembly 28 is introduced into sample introduction chamber 16, and the sample is eluted from the sample acquisition device. By folding frame 14 along axis A, a first flow path is formed through apparatus 10. The first flow path is defined by sample introduction chamber 16, capture chamber 18, and waste chamber 20. When frame 14 is folded along axis A, pathway 29 from fluid reservoir 22 to capture chamber 18 is essentially closed off, for example at flow restrictor location 30 (shown in FIG. 1B). While pathway 29 may not be entirely closed, fluid flow is discouraged through pathway 29 in order to encourage fluid flow from sample introduction chamber 16, through capture chamber 18, and to waste chamber 20.

After the sample is eluted from sample acquisition assembly 28, the eluted sample flows along the first flow path created by frame 14 folded along axis A. The eluted sample moves from sample introduction chamber 16, through capture chamber 18, and to waste chamber 20. As the eluted sample flows through capture chamber 18, the eluted sample moves through capture medium 19. Preferably, capture medium 19 is positioned and retained in such a way that fluid may pass over and through capture medium 19 while at the same time allowing capture medium 19 to capture and isolate the analyte from the eluted sample.

After the eluted sample moves through capture medium 19, the remainder of the eluted sample (minus the captured analyte), which are no longer necessary for the assay, flow along the first flow path to waste chamber 20. In some embodiments, an absorbent material is disposed in waste chamber 20 in order to retain the waste fluid in sufficient quantity in order to decrease the possibility that the waste fluid will flow into the other chambers 16, 18, 22, or 24, the occurrence of which may contaminate the assay. In alternate embodiments, other means for retaining waste fluid are used.

After the waste fluid has flowed to waste chamber 20, sample acquisition assembly 28 may be removed from sample introduction chamber 16. Frame 14 is then manipulated to alter a flow path through chambers 16, 18, 20, 22, and 24. In the exemplary embodiment, frame 14 is unfolded along axis A (to the position shown in FIG. 1A), and then folded along axis B (shown in FIG. 1A). The resulting configuration of frame 14 is shown in FIG. 3. By folding frame 14 along axis B, a second flow path is formed through apparatus 10. The second flow path is defined by fluid reservoir 22, capture chamber 18, and testing chamber 24. When frame 14 is folded along axis B, a portion of sample introduction chamber 16 (designated as pathway 31) is essentially closed off, for example at flow restrictor location 32 (shown in FIG. 1B). While pathway 31 may not be entirely closed, fluid flow is discouraged through pathway 32 in order to encourage fluid flow from fluid reservoir 22, through capture chamber 18, and to testing chamber 24.

After frame 14 is folded along axis B, apparatus 10 is rotated 90° so that frame 14 is resting on stand 26. This configuration of apparatus 10 is shown in FIG. 4. After frame 14 is folded along axis B, second fluid 23 disposed in fluid reservoir 22 may be released. The exemplary second fluid 23 is a second buffer solution. Once again, the type of buffer solution that is to be incorporated into the assay is dependent upon many factors, including the analyte that apparatus 10 is configured to detect. In the exemplary embodiment, frangible seal 25 is disposed in pathway 29 between fluid reservoir 22 and capture chamber 18. An operator may pressurize fluid reservoir 22, such as by pressing down on fluid reservoir 22 with the operator's thumb or fingers, in order to break frangible seal 25. Frangible seal 25 allows second fluid 23 to be selectively released from fluid reservoir 22, and helps second fluid 23 remain in fluid reservoir 22 during storage of apparatus 10. After being released, second fluid 23 moves through capture medium 19 disposed in capture chamber 18 and releases at least some of the analyte from capture medium 19.

Prior to contacting testing device 30, any analyte that is present is placed in contact with a reagent adapted to react with the analyte in order for the indirect assay to run properly. Because the reagent is likely dehydrated in order to keep the reagent stable during storage of apparatus 10, second fluid 23 retained in fluid reservoir 22 may be used to reconstitute the reagent, and reactivate it. In the exemplary embodiment, a dehydrated reagent is disposed within pathway 29 and is retained in frangible pouch 34 (shown in FIG. 1B). Frangible pouch 34 is formed along pathway 29 in such a manner that when an operator pressurizes fluid reservoir 22, frangible pouch 34 also breaks. This is similar to the description of how an applied pressure to a fluid reservoir ruptures an adjacent barrier described in U.S. Patent Application Publication No. 2003/0214997, published on Nov. 20, 2003.

Where the reagent and analyte react depends on where the reagent is disposed. However, it is preferred that the analyte react with a reagent at some time prior to contacting the testing device disposed in testing chamber 24 because as previously stated, in an indirect assay, it is the reagent that reacts with the testing device. Apparatus 10 may be agitated in order to help the reagent and analyte react. In alternate embodiments, the dehydrated reagent may be disposed within any suitable place within apparatus 10. For example, the dehydrated reagent may be disposed in pathway 36 between capture chamber 18 and testing chamber 24.

After second fluid 23 releases at least some of the analyte from capture medium 19, second fluid 23 and the released analyte flow along the second flow path into retention cavity 37 (shown in FIG. 1B) of testing chamber 24. Preferably, the released analyte is mixed with a reagent prior to entering testing chamber 24. As shown in FIG. 1B, disposed within testing chamber 24 is retention cavity 37, testing device 38, fluid path 40 (such as a channel) connecting retention cavity 37 to testing device 38, and absorbent material 42. In the exemplary embodiment, fluid path 40 includes microfluidic element for controlling the flow of fluid from the retention cavity 37 to testing device 38. Testing device 38 may require fluid to flow past it at or below a certain rate in order for the reagent in the fluid to react with testing device 38. One or more microfluidic elements may help regulate this fluid flow past testing device 38. In order to encourage fluid flow past testing device 38, absorbent material 42 is positioned in testing chamber 24, where testing device 38 is positioned between fluid path 40 and absorbent material 42. Absorbent material 34 may help the fluid flow past testing device 30 by creating a wicking action.

Testing device 38 provides a visual indicium of whether the analyte is present in the sample of material collected with sample acquisition assembly 28 (shown in FIGS. 1B and 2), and in some embodiments, the test result indicates the quantity of analyte.

After a sufficient amount time to allow any remaining reagent (i.e., the reagent that has not reacted with the analyte) to react with testing device 38, a user may read the test result in window 27 (shown in FIG. 1A). The reaction time depends upon many factors, including the type of analyte and/or reagent.

Because it is not likely that the fluid formed by the reagent/analyte/second fluid will contact testing device 38 until frame 14 is rotated about 90°, the exemplary embodiment allows an operator to control the timing of the assay.

Although the present invention has been described with reference to preferred embodiments, workers skilled in the art will recognize that changes may be made in form and detail without departing from the spirit and scope of the invention.

The complete disclosures of the patents, patent documents and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. An apparatus for processing a sample of material, the apparatus comprising:
a frame;
a housing material attached to the frame, the housing material forming a plurality of chambers comprising:
a sample introduction chamber configured to receive the sample of material;
a waste chamber in fluid communication with the sample introduction chamber;
a fluid chamber configured to retain a fluid;
a testing chamber comprising a testing device capable of testing the sample of material; and
a capture medium interposed in a flow path between the sample introduction chamber and the waste chamber and a flow path between the fluid chamber and the testing chamber and the frame being bendable along at least one of a first axis to restrict flow to the fluid chamber and a second axis to restrict flow to the sample introduction chamber.

2. The apparatus of claim 1, wherein the housing material, together with the frame, form the plurality of chambers.

3. The apparatus of claim 1, wherein the housing material comprises a flexible film.

4. The apparatus of claim 1, wherein the frame is bending along both the first and second axes.

5. The apparatus of claim 1, wherein the frame is formed of a semi-rigid material.

6. The apparatus of claim 1, wherein the testing device comprises a calorimetric sensor for providing a visual indicium of a test result.

7. The apparatus of claim 6, wherein the calorimetric sensor comprises a polydiacetylene material.

8. The apparatus of claim 1, wherein the waste chamber comprises an absorbent material.

9. The apparatus of claim 1, further comprising a reagent adapted to react with the analyte, wherein the reagent is disposed in the fluid chamber, and wherein the reagent is separated from the fluid retained in the fluid chamber by a frangible seal.

10. The apparatus of claim 1, further comprising a reagent adapted to react with the analyte, wherein the reagent is disposed a capture chamber having the capture medium therein.

11. A method of detecting an analyte in a sample of material, the method comprising:
introducing the sample of material into a sample introduction chamber of an apparatus and eluting the sample of material;
capturing the eluted sample of material using a capture medium;
folding a frame of the apparatus along an axis; and
releasing a fluid from a fluid reservoir and directing the fluid along a flow path through the capture medium to a testing chamber.

12. A method of detecting an analyte in a sample of material, the method comprising:
introducing a sample of material into a sample introduction chamber of an apparatus and eluting the sample of material;
capturing the eluted sample of material using a capture medium;
rotating the apparatus about 90°; and
releasing a fluid disposed in a fluid reservoir and directing the fluid along a flow path through the capture medium to a testing chamber.

13. The method of claim 11, wherein prior to releasing the fluid from the fluid reservoir comprising the step of:
rotating the frame about 90 degrees.

14. The method of claim 11 and further comprising the step of:
folding the frame along another axis prior to capturing the eluted sample of material.

15. The method of claim 11, wherein the frame is folded along a predetermined fold line.

16. The method of claim 11, and further comprising the step of:
combining the sample of material with a reagent adapted to react with the analyte.

17. The method of claim 11, and further comprising the step of:
breaking a frangible seal to release the fluid or reagent from the fluid reservoir.

18. The method of claim 12, and further comprising the step of:
combining the sample of material with a reagent adapted to react with the analyte.

19. The method of claim 12, and further comprising the step of:
breaking a frangible seal to release the fluid or reagent from the fluid reservoir.
